(19) United States
(12) Patent Application Publication
(10) Pub. No.: US 2010/0226624 A1
(43) Pub. Date: Sep. 9, 2010

(54) INFORMATION PROCESSING APPARATUS, PLAYBACK DEVICE, RECORDING MEDIUM, AND INFORMATION GENERATION METHOD

(75) Inventors: Akihiro YAMORI, Kawasaki (JP); Shunsuke Kobayashi, Fukuoka (JP); Akira Nakagawa, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/716,805

(22) Filed: Mar. 3, 2010

(30) Foreign Application Priority Data
Mar. 4, 2009 (JP) 2009-51024

(51) Int. Cl. H04N 7/087

(52) U.S. Cl. 386/84

(57) ABSTRACT

A detecting section in an information processing apparatus is configured to detect an event sound from audio, the audio having been recorded when video was shot. The information processing apparatus also includes a calculating section configured to determine an event playback time at which an image associated with the event sound is played back in a video playback time sequence, the video playback time sequence corresponding to a playback speed lower than a shooting speed of the video and a determining section configured to determine a playback start time of the event sound during the video playback time sequence in accordance with the event playback time.

### CROSS-REFERENCE TO RELATED APPLICATIONS

This application is based upon and claims the benefit of priority from the prior Japanese Patent Application No. 2009-51024 filed on Mar. 4, 2009, the entire contents of which are incorporated herein by reference.

### BACKGROUND

1. Field

Embodiments discussed herein relate to an information processing apparatus configured to generate information relating to audio playback involved in playback of video at a speed lower than a shooting speed.

2. Description of the Related Art

In general, a moving image is generated using 30 or 60 still images per second. Each of the still images forming a moving image is called a frame. The number of frames per second is called the frame rate and is expressed in terms of a unit called frame per second (fps). In recent years, devices configured to shoot frames at a frame rate as high as 300 fps or 1200 fps have been available. The frame rate during shooting is called the shooting rate or recording rate.

On the other hand, the standard for playback devices (or display devices) such as television receivers specifies a maximum frame rate of 60 fps for playback. The frame rate at which video is played back is called the playback rate. In a case where, for example, video frames shot at 900 fps are played back using such a playback device, a group of video frames is played back as slow motion video. For example, a playback device set to a playback rate of 30 fps plays back this video at a speed that is 1/30 times the shooting rate. A playback device set to a playback rate of 60 fps plays back this video at a speed that is 1/15 times the shooting rate.

In a case where video shot at a high shooting rate is played back at a low playback rate, playback of audio at a rate that is 1/30 times or 1/15 times, like the video, makes the audio unintelligible. Thus, in general, no sound is played back when video shot at a high shooting rate is slowly played back.

### SUMMARY

According to an aspect of an embodiment, an information processing apparatus includes a detecting section configured to detect an event sound from audio, the audio being recorded when video is shot, a calculating section configured to determine an event playback time at which an image associated with the event sound is played back in a video playback time sequence, the video playback time sequence corresponding to a playback speed lower than a shooting speed of the video and a determining section configured to determine a an audio playback start time of the event sound during the video playback time sequence in accordance with the event playback time.

Additional aspects and/or advantages will be set forth in part in the description which follows and, in part, will be apparent from the description, or may be learned by practice of the invention.

The above-described embodiments of the present invention are intended as examples, and all embodiments of the present invention are not limited to including the features described above.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a block diagram that illustrates an example hardware configuration of an information processing apparatus;

FIG. 2 is a block diagram illustrating functions implemented by executing a program using an information processing apparatus;

FIG. 3 is a block diagram that illustrates an example configuration of an information processing apparatus;

FIG. 4 is a hybrid diagram containing a sequence of images and a graph of audio illustrating an example of the calculation of an audio playback start time of an audio frame group in which an event is detected;

FIG. 5 is a flowchart that illustrates an example of a process flow of an information processing apparatus;

FIG. 6 is a flowchart that illustrates an example of a process flow for determining a time range for which event detection is to be performed;

FIG. 7 is a flowchart illustrating an example of a subroutine for a period flag;

FIG. 8 is a graph that illustrates an example of a result obtained using a process of extracting a time range for which event detection is to be performed.

### DETAILED DESCRIPTION OF THE EMBODIMENTS

Embodiments will now be described with reference to the drawings. The configurations of the following embodiments are merely examples, and the present invention is not to be limited to the configurations of such embodiments.

### <Hardware Configuration of Information Processing Apparatus>

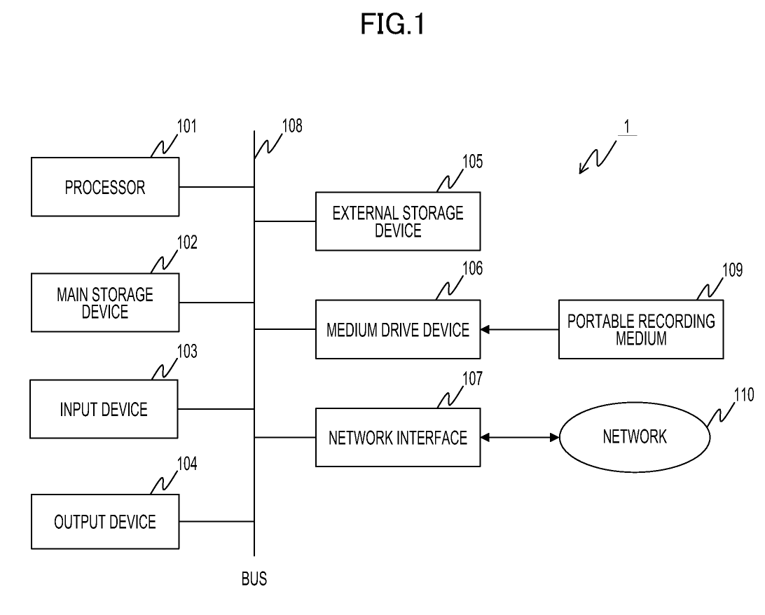

FIG. 1 illustrates an example hardware configuration of an information processing apparatus 1. The information processing apparatus 1 includes a processor 101, a main storage device 102, an input device 103, an output device 104, an external storage device 105, a medium drive device 106, and a network interface 107. The above devices are connected to one another via a bus 108.

The input device 103 includes, for example, an interface that is connected to devices such as a camera configured to shoot video at a predetermined shooting rate and a microphone configured to pick up audio when video is shot. The camera shoots video at a predetermined shooting rate, and outputs a video signal. The microphone outputs an audio signal corresponding to the picked up audio.

Here, the camera may capture video at a rate of, for example, 300 fps. On the other hand, the microphone may record audio at a sampling frequency of, 48 kHz, 44.1 kHz, 32 kHz, or the like when using, for example, Advanced Audio Coding (AAC) as an audio compression format. In the input device 103 having the above configuration, when the shooting of video and the recording of audio are performed at the same time, the audio is recorded at a rate lower than the shooting rate (that is, the recording rate) of the video.

Examples of the processor 101 may include a central processing unit (CPU) and a digital signal processor (DSP). The processor 101 loads an operating system (OS) or various application programs, which are stored in the external storage device 105, onto the main storage device 102 and executes them, thereby performing various video and audio processes.

For example, the processor 101 executes a program to perform an encoding process on a video signal and an audio signal, which are input from the input device 103, and obtains video data and audio data. The video data and the audio data are stored in the main storage device 102 and/or the external storage device 105. The processor 101 also enables various types of data including video data and audio data to be stored in portable recording media using the medium drive device 106.

The processor 101 further generates video data and audio data from a video signal and an audio signal received through the network interface 107, and enables the video data and the audio data to be recorded on the main storage device 102 and/or the external storage device 105.

The processor 101 further transfers video data and audio data, which are read from the external storage device 105 or a portable recording medium 109 using the medium drive device 106, to a work area provided in the main storage device 102, and performs various processes on the video data and the audio data. The video data includes a video frame group. The audio data includes an audio frame group. The processes performed by the processor 101 include a process for generating data and information for playing back video and audio from the video frame group and the audio frame group. This process will be described in detail below.

The processor 101 uses the main storage device 102 as a storage area and a work area onto which a program stored in the external storage device 105 is loaded or as a buffer. Examples of the main storage device 102 may include a semiconductor memory such as a random access memory (RAM).

The output device 104 outputs a result of the process performed by the processor 101. The output device 104 includes, for example, a display and speaker interface circuit.

The external storage device 105 stores various programs and data used by the processor 101 when executing each program. The data includes video data and audio data. The video data includes a video frame group, and the audio data includes an audio frame group. Examples of the external storage device 105 may include a hard disk drive (HDD).

The medium drive device 106 reads and writes information from and to the portable recording medium 109 in accordance with an instruction from the processor 101. Examples of the portable recording medium 109 may include a compact disc (CD), a digital versatile disc (DVD), and a floppy or flexible disk. Examples of the medium drive device 106 may include a CD drive, a DVD drive, and a floppy or flexible disk drive.

The network interface 107 may be an interface configured to input and output information to and from a network 110. The network interface 107 is connected to wired and wireless networks. Examples of the network interface 107 may include a network interface card (NIC) and a wireless local area network (LAN) card.

Examples of the information processing apparatus 1 may include a digital video camera, a display, a personal computer, a DVD player, and an HDD recorder. An integrated circuit (IC) chip or the like stored therein may also be an example of the information processing apparatus 1.

### First Embodiment

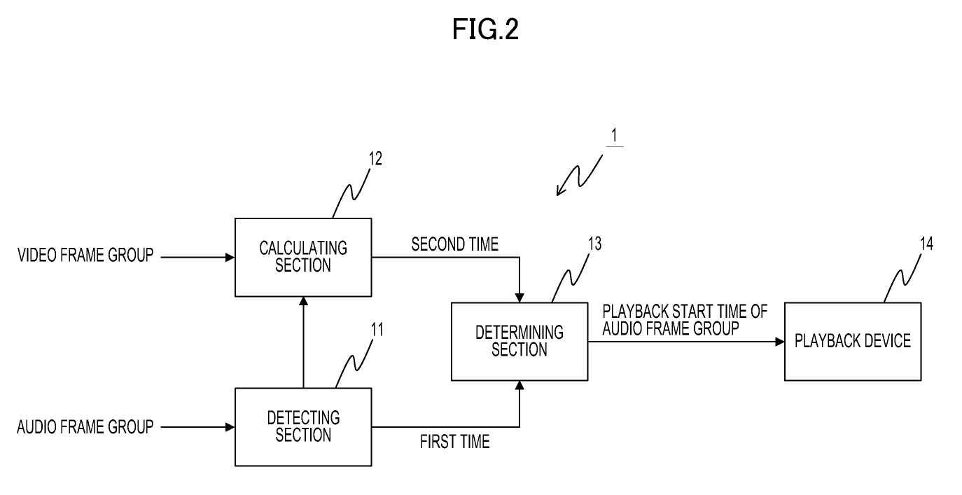

FIG. 2 is a diagram illustrating functions implemented by executing a program using the processor 101 of the information processing apparatus 1. The information processing apparatus 1 is implemented as a detecting section 11, a calculating section 12, and a determining section 13 by executing a program using the processor 101. That is, the information processing apparatus 1 functions as an apparatus including the detecting section 11, the calculating section 12, and the determining section 13 through the execution of a program.

A video file including video data and an audio file including audio data are input to the information processing apparatus 1. The video file includes a video frame group, and the audio file includes an audio frame group. The audio frame group includes the audio of an event included in the video frame group. In other words, the audio frame group includes audio that is recorded when an event included in the video of the video frame group is shot.

The detecting section 11 obtains, as an input, an audio frame group of audio that is recorded when video is shot. The detecting section 11 detects a first time at which an audio frame including event sound corresponding to the event is to be played back when audio based on the audio frame group is played back. The first time may be a time measured with respect to a recorded group start time corresponding to the playback start position of the audio frame group, i.e., the audio file. The detecting section 11 outputs the first time to the determining section 13. The audio frame including the event sound may be, for example, an audio frame having the maximum volume level in the audio frame group.

The calculating section 12 obtains a video frame group as an input. The video frame group is generated at a shooting speed (shooting rate) higher than the playback speed (playback rate) of the video frame group. The calculating section 12 detects a second time at which a video frame including the event is to be played back in a video playback time sequence corresponding to the playback speed lower than the shooting speed. The second time may be a time measured with respect to the time corresponding to the playback start position of the video frame group. The calculating section 12 outputs the second time to the determining section 13. The second time is determined by, for example, multiplying the first time by the ratio of the shooting speed of the video frame group to the playback speed.

The determining section 13 obtains, i.e., receives as inputs, the first time and the second time, as defined above, from the detecting and calculating sections 11 and 12, respectively. The determining section 13 subtracts the first time from the second time and determines the resulting time as the audio playback start time of the audio frame group with respect to the video playback start time of the video frame group. The determining section 13 outputs the audio playback start time of the audio frame group with respect to the video playback start time of the video frame group.

A playback device 14 provided after the information processing apparatus 1 receives, as inputs, the video frame group, the audio frame group, and the audio playback start time of the audio frame group with respect to the video playback start time of the video frame group.

The playback device 14 plays back the audio frame group at the audio playback start time obtained from the information processing apparatus 1 after starting playback of the video frame group, thereby playing back the video frame including the event and the audio frame including the event sound at the same time. Therefore, the information processing apparatus 1 can provide information that enables a video frame including an event and an audio frame including event sound to be played back at the same time in a case where a video frame group is played back at a speed lower than the shooting speed.

The processor 101 of the information processing apparatus 1 obtains, for example, a video frame group and an audio frame group as inputs from the input device 103, the external storage device 105, the portable recording medium 109, or the network interface 107. For example, the processor 101 reads a program stored in the external storage device 105 or reads a program recorded on the portable recording medium 109 via the medium drive device 106, and loads the program onto the main storage device 102 for execution. The processor 101 executes the program to perform respective processes of the detecting section 11, the calculating section 12, and the determining section 13. The processor 101 outputs, as a result of executing the program, the audio playback start time of the audio frame group with respect to the video playback start time of the video frame group to, for example, the output device 104, the external storage device 105, and any other suitable device.

### Second Embodiment

An information processing apparatus according to a second embodiment is configured to generate information that enables a video frame and an audio frame to be played back at the same time in a case where a video frame group generated at a high frame rate is slowly played back at the display rate of a display device.

In the second embodiment, the audio frame group is played back at the same rate as the number of samples n per second. That is, in the audio frame group, n samples are output per second. The term “audio frame” is analogous to sample, and a frame time occupied by one audio frame is equal to the time of one sample (1/n second).

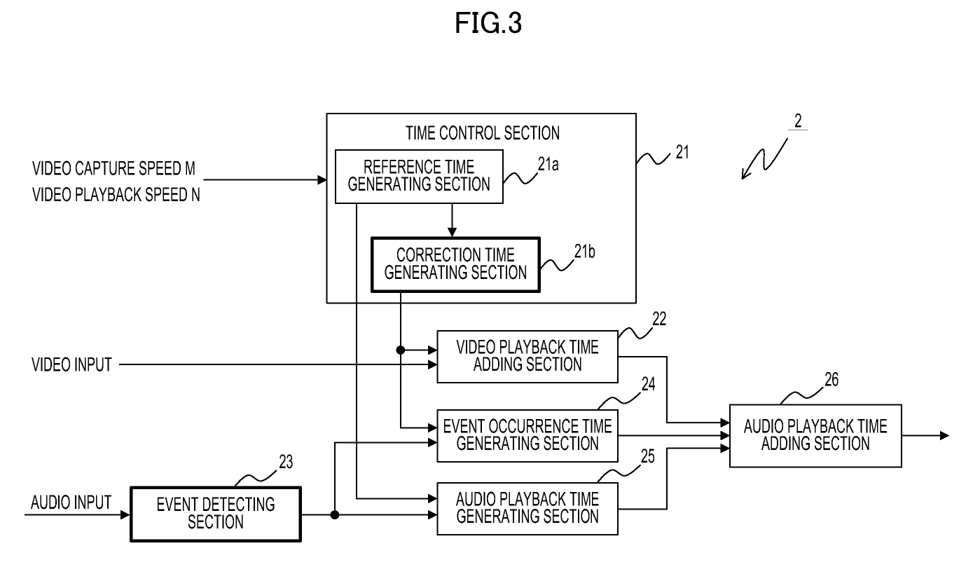

FIG. 3 illustrates an example configuration of an information processing apparatus 2. The information processing apparatus 2 includes a time control section 21, a video playback time adding section 22, an event detecting section 23, an event occurrence time generating section 24, an audio playback time generating section 25, and an audio playback time adding section 26. The information processing apparatus 2 has a hardware configuration similar to the information processing apparatus 1.

The time control section 21 receives, as inputs, a video capture speed and a video playback speed. The video capture speed is a frame rate at which a video frame group is captured by the input device 103 (FIG. 1). The video playback speed is the playback rate or display rate of the output device 104 (FIG. 1) capable of playing back a video frame group and an audio frame group or a playback device, similar to playback device 14 in FIG. 2, provided after the information processing apparatus 2. In this embodiment, the video capture speed is represented by M (in fps) and the video playback speed is represented by N (in fps). The video capture speed M is higher than the video playback speed N. That is, the video capture speed M and the video playback speed N have a relationship of M>N. In this case, the video frame group is slowly played back at a speed that is N/M times the normal (video capture) speed. The time control section 21 reads the video capture speed and the video playback speed, which are stored in, for example, the external storage device 105 (FIG. 1). Alternatively, the time control section 21 obtains the video playback speed of the playback device using the network interface 107 (FIG. 1) or any other suitable device.

The time control section 21 includes a reference time generating section 21a and a correction time generating section 21b. The reference time generating section 21a generates a reference time. The reference time may be implemented based on clock signals generated by the processor 101 (FIG. 1) or using the activation time of the information processing apparatus 2. The reference time generating section 21a outputs the reference time to the correction time generating section 21b and the audio playback time generating section 25.

The correction time generating section 21b receives the reference time as an input. The correction time generating section 21b generates a time at which the video frame group is played back at the video playback speed N on the basis of the reference time. The correction time generating section 21b multiplies the reference time by the ratio of the video capture speed M to the video playback speed N, i.e., M/N, to determine a correction time. The correction time generating section 21b outputs the correction time to the video playback time adding section 22 and the event occurrence time generating section 24.

The video playback time adding section 22 receives, as an input, the correction time and a video frame. The video playback time adding section 22 adds a timestamp to the input video frame, where the timestamp represents a playback time TVout of the video frame. The video playback time adding section 22 starts counting at 0, which represents the time at which the input of the video frame is started, that is, the time at which the first frame in the video frame group is input. The playback time TVout of the video frame is the correction time input from the correction time generating section 21b when the video frame is input. When the reference time at which the video frame is input to the information processing apparatus 2 is denoted by TVin, the playback time TVout is represented by Formula (1) as follows:

$$TVout = TVin \times \frac{M}{N} \qquad Λ ( 1 )$$

The video playback time adding section 22 outputs the video frame to which a timestamp representing the playback time TVout has been added.

The event detecting section 23 obtains an audio frame. The event detecting section 23 detects the occurrence of an event in the audio frame group. An event may be a phenomenon in which a sound with a volume level equal to or greater than a certain level occurs for a short period of time. Examples of the event may include phenomena of a bullet hitting a glass, a golf club head hitting a golf ball, and a tennis ball being hit with a tennis racket.

The event detecting section 23 determines the volume level for each audio frame input thereto, and causes the main storage device 102 (FIG. 1) to buffer the volume levels. The event detecting section 23 determines whether or not each of the buffered volume levels of the first frame to the last frame in the audio frame group satisfies Formulas (2) and (3) as follows:

Maximum volume level>ThAMaxΛ (2)

Non-maxium volume level<ThAMinΛ (3)

where ThAMax denotes the maximum threshold volume level and ThAMin denotes the minimum threshold volume level.

When Formulas (1) and (2) are satisfied, the event detecting section 23 detects an event in the audio frame group. The event detecting section 23 outputs an event detection result for the audio frame group to the event occurrence time generating section 24.

When an event is detected, the event detecting section 23 outputs event detection result “ON”, which indicates the occurrence of an event, and information about an audio frame having the maximum volume level to the event occurrence time generating section 24. Examples of the information about the audio frame may include an identifier included in the audio frame.

When no events are detected, the event detecting section 23 outputs event detection result “OFF”, which indicates no events, to the event occurrence time generating section 24. The event detecting section 23 sequentially calculates the volume levels of audio frames input thereto, and outputs, for example, the audio frames at a speed of n audio frames per second to the event occurrence time generating section 24 and the audio playback time generating section 25. In the following description, an audio frame having the maximum volume level in a case where an event has been detected is referred to as an “audio frame having the event”.

The audio playback time generating section 25 receives, as an input, the reference time and an audio frame that is input at a speed of n audio frames per second. The audio playback time generating section 25 adds a timestamp to the audio frame that is input at a speed of n audio frames per second, where the timestamp represents a playback time TAout of the audio frame.

The audio playback time generating section 25 starts counting at 0, which represents the time at which the input of the audio frames starts, that is, the time at which the first frame in the audio frame group is input.

The playback time TAout of the audio frame is the reference time input from the reference time generating section 21a when the audio frame is input. When the reference time at which the audio frame is input is denoted by TAin, the playback time TAout is represented by Formula (4) as follows:

TAout=TAinΛ (4)

In the second embodiment, since it is assumed that an audio frame is played back at the same speed as the speed at which the audio frame is generated, Formula (4) holds true. The audio playback time generating section 25 outputs the audio frame to which a timestamp representing the playback time TAout has been added.

The event occurrence time generating section 24 obtains, as an input, an audio frame that is input at a speed of n audio frames per second, an event detection result, and the correction time. The event occurrence time generating section 24 starts counting the correction time at 0, which represents the time at which the input of the audio frame starts, that is, the time at which the first frame in the audio frame group is input. Each time an audio frame is input, the event occurrence time generating section 24 causes the main storage device 102 (FIG. 1) to buffer the identifier of the audio frame and the correction time at which the audio frame is input.

Upon receipt of event detection result “ON”, which indicates the occurrence of an event, and information about an audio frame having the maximum volume level, the event occurrence time generating section 24 reads the time at which the audio frame is input from the buffer, and outputs the result as a video correction time TEout.

When the reference time at which the audio frame having the maximum volume level is input is represented by an audio reference time TEin, the video correction time TEout, which indicates the corresponding correction time, is represented by Formula (5) as follows:

$$TEout = TEin \times \frac{M}{N} \qquad Λ ( 5 )$$

According to Formula (5), the video correction time TEout is the time at which a video frame having the event is output in a case where the video frame group is played back at the video playback speed N. That is, the video correction time TEout is an event occurrence time at which the event occurs in a video playback time sequence in a case where the video frame group is played back at the video playback speed N. The audio reference time TEin is the time at which the event occurs on an audio playback time sequence in a case where the audio frame group is played back at a speed of n audio frames per second. The event occurrence time generating section 24 transmits the video correction time TEout and information about the audio frame having the event to the audio playback time adding section 26. When event detection result “OFF” is obtained, the event occurrence time generating section 24 discards the identifier of the audio frame and the correction time at which the audio frame is input, which are buffered.

The audio playback time adding section 26 receives, as an input, the audio frame to which the playback time TAout has been added, the video correction time TEout, and information about the audio frame having the event. The audio playback time adding section 26 causes the main storage device 102 (FIG. 1) to buffer the input audio frame. When the video correction time TEout is not input, that is, when no events are detected, the audio playback time adding section 26 does not output an audio frame. When the video correction time TEout is input, that is, when an event is detected, the audio playback time adding section 26 executes a process of adding the same time to a video frame having the event and an audio frame having the event.

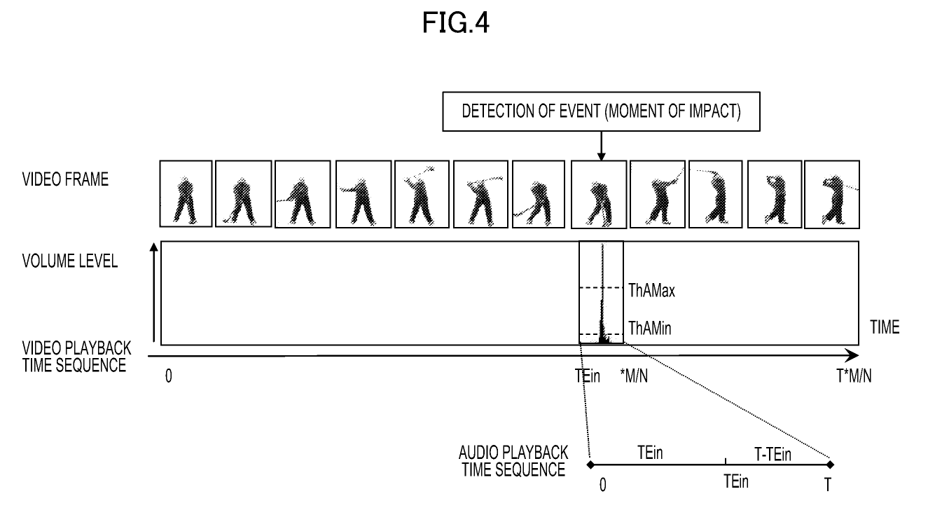

FIG. 4 is a diagram illustrating an example of the calculation of the audio playback start time of an audio frame group in which an event is detected. In FIG. 4, a golf swing scene is used by way of example. An event in the golf swing scene may be a phenomenon of a golf club head hitting a golf ball. This phenomenon is generally called “impact”. The sound generated upon impact is called “impact sound”. The event detecting section 23 detects an impact sound from the audio frame group to detect the occurrence of an event. The audio playback time adding section 26 calculates the audio playback start time of the audio frame group so that the impact sound can be played back at the time when the video frame of the impact is played back.

The audio playback time adding section 26 reads, as the audio reference time TEin, the time added to the audio frame having the event from the input information about the audio frame having the event. The audio playback time adding section 26 calculates a playback start time TAstart of the audio frame group using the input video correction time TEout and audio reference time TEin.

TAstart=TEout−TEin
From Equation (5), the following equation can be obtained:

$$TAstart = TEin \times \frac{M}{N} - TEin = TEin ( \frac{M}{N} - 1 ) \qquad Λ ( 6 )$$

The audio playback time adding section 26 adds the audio frame playback time TAout again using the playback start time TAstart as an offset. That is, the audio playback time adding section 26 calculates the playback time TAout of the audio frame using Formula (7) as follows:

TAout=TAout+TAstartΛ (7)

The audio playback time adding section 26 outputs the audio frame to which the playback time TAout of the audio frame has been added. Using Formulas (6) and (7) allows synchronization between the output times of the video frame having the event and the audio frame having the event. That is, as illustrated in FIG. 4, the audio playback time sequence is offset so that when the video frame group is played back at the video playback speed N, the event occurrence time in the video playback time sequence and the event occurrence time in the audio playback time sequence can match each other.

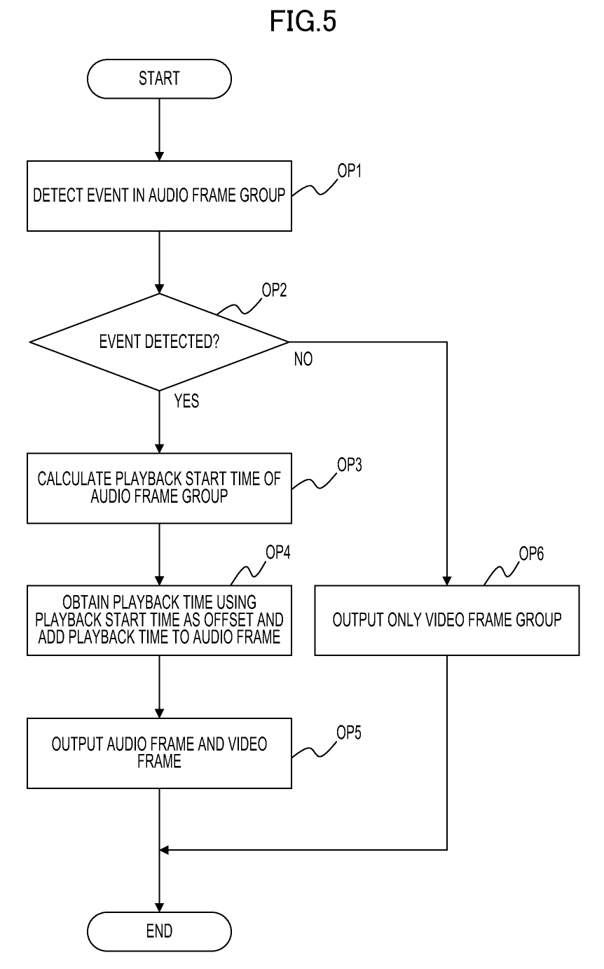

FIG. 5 illustrates an example of a process flow of the information processing apparatus 2. Upon receipt of an audio frame and a video frame, the information processing apparatus 2 reads a program from, for example, the external storage device 105 (FIG. 1), and executes the flow illustrated in FIG. 5.

The information processing apparatus 2 detects an event from an audio frame group (OP1). For example, as described above, the event detecting section 23 detects the occurrence of an event in the audio frame group.

When an event is detected (OP2: Yes), the information processing apparatus 2 calculates the playback start time TAstart of the audio frame group (OP3). The playback start time TAstart is calculated by the audio playback time adding section 26 using Formula (6).

In the information processing apparatus 2, the audio playback time adding section 26 adds a playback time TAout obtained using the playback start time TAstart as an offset, which is determined using Formula (7), to each of the audio frames (OP4). Thereafter, the information processing apparatus 2 outputs the audio frame group and the video frame group (OP5).

When no events are detected (OP2: No), the information processing apparatus 2 outputs only the video frame group (OP6).

In each of the video frames output in OP5 and OP6, a playback time at which the video frame is played back at the video playback speed N has already been added by the video playback time adding section 22.

The information processing apparatus 2 adds to a video frame a playback time at which the video frame is played back at the video playback speed N. The information processing apparatus 2 further adds to an audio frame a playback time at which the audio frame is played back at a speed of n audio frames per second. In this case, the information processing apparatus 2 adds the same time to an audio frame and a video frame having an event. For example, the information processing apparatus 2 multiplies the playback time of the audio frame having the event by the ratio of the video capture speed M to the video playback speed N to determine the playback time of the video frame having the event. The information processing apparatus 2 subtracts the playback time of the audio frame having the event from the playback time of the video frame having the event to calculate the playback start time of the audio frame group. The information processing apparatus 2 adds a playback time, which is obtained using the playback start time of the audio frame group as an offset, to each audio frame. This allows the generation of an audio frame group having playback times added thereto such that an audio frame having an event can be played back at the playback time of a video frame having the event. For example, when a playback device 14 (FIG. 2) provided after the information processing apparatus 2 plays back the audio frame group and the video frame group at the video playback speed N in accordance with the playback times added to the audio frames and the video frames, the video frame having the event and the audio frame having the event are played back at the same time. Therefore, the information processing apparatus 2 can provide information that enables a video frame having an event and an audio frame having the event to be played back at the same time in a case where a video frame group captured at the video capture speed M is played back at the video playback speed N.

The processor 101 of the information processing apparatus 2 receives, as an input, for example, a video frame group and an audio frame group from one of the input device 103, the external storage device 105, the portable recording medium 109 via the medium drive device 106, and the network interface 107. For example, the processor 101 reads a program stored in the external storage device 105 or a program recorded on the portable recording medium 109 by using the medium drive device 106, and loads the program onto the main storage device 102 for execution. The processor 101 executes this program to perform respective processes of the time control section 21 (the reference time generating section 21a and the correction time generating section 21b), the video playback time adding section 22, the event detecting section 23, the event occurrence time generating section 24, the audio playback time generating section 25, and the audio playback time adding section 26. The processor 101 outputs, as a result of executing the program, the video frame group and the audio frame group in which a playback time is added to each frame to, for example, the output device 104, the external storage device 105, and any other suitable device.

### Example Modification 1

In the second embodiment described above, a timestamp representing a playback time is added to a video frame and an audio frame. Alternatively, when the information processing apparatus 2 is provided with a display device such as a display as an output device, the playback start time TAstart of an audio frame group may be determined on the basis of the playback start time of a video frame group without timestamps being added. That is, the display device may start playing back (or displaying) the video frame group and then start playing back the audio frame group at the playback start time TAstart.

### Example Modification 2

In the second embodiment described above, an audio frame group is generated with a sampling rate of n samples per second and is played back at a speed of n audio frames per second, that is, the audio capture speed and playback speed are equal to each other, by way of example. Alternatively, in accordance with the ratio of the video capture speed M to the video playback speed N, an audio frame group may be slowly played back at an audio playback speed lower than a speed of n audio frames per second.

In this case, for example, the correction time generating section 21b illustrated in FIG. 3 generates an audio correction time as a correction time for the audio frame group.

Here, the speed at which audio is played back is defined as an audio playback speed s (as playing back s audio frames per second). Furthermore, the speed at which audio is captured is defined as an audio capture speed n (the number of samples n per second). The information processing apparatus 2 determines the audio playback speed s on the basis of the ratio of the video capture speed M to the video playback speed N, i.e., M/N. A coefficient for controlling the speed in terms of what fraction of the video playback speed audio is slowly played back at is defined as a degree of slow playback β and is given as follows:

$$β = α \times \frac{M}{N} ( \frac{N}{M} < α < 1 , i . e . , 1 < β < \frac{M}{N} )$$

$$s = \frac{1}{β} \times n$$

Since the audio playback speed s which is greater than the audio capture speed n provides fast playback rather than slow playback, a coefficient α for controlling the degree of slow playback has a lower limit. Furthermore, since it is not necessary to slowly play back the audio frame group at the same speed (N/M times) as that of the video frame group, the coefficient α for controlling the degree of slow playback may have a value less than 1. That is, N/M<α<1.

The correction time generating section 21b multiplies the reference time by the ratio of the audio capture speed n to the audio playback speed s, i.e., n/s, to determine the audio correction time for the audio frame group. When the reference time at which an audio frame is input is denoted by TAin, the audio frame playback time TAout at which the audio frame group is played back at the audio playback speed s is determined as follows:

$$TAout = TAin \times \frac{n}{s} = TAin \times β$$

Similarly, the timestamp of the audio frame is generated on the basis of the audio correction time. Therefore, when the reference time at which an audio frame having a maximum volume level in a case where an event is detected is input is represented by an audio reference time TEin, the playback time TAEin at which this frame is played back is determined as follows:

$$TAEin = TEin \times \frac{n}{s} = TEin \times β$$

A video correction time TEout, which is an event occurrence time at which the event occurs in the video playback time sequence, has the same value as that in the second embodiment. Therefore, when the audio capture speed is denoted by n and the audio playback speed is denoted by s, the playback start time TAstart of the audio frame group is determined as follows:

$$\begin{matrix}TAstart = TEout - TEAin \\ = TEin \times \frac{M}{N} - TEin \times β \\ = TEin ( \frac{M}{N} - β )\end{matrix}$$

Therefore, even in a case where the audio capture speed and the audio playback speed are different from each other, that is, audio is also slowly played back, the playback start time TAstart of the audio frame group to be played back is calculated so that an audio frame having an event and a video frame having the event can be played back at the same time.

The audio playback speed may also be changed to low speed in accordance with the ratio of the video playback speed to the video capture speed, thereby allowing more realistic audio to be output so as to be suitable for a video scene.

### Example Modification 3

In the second embodiment described above, event detection is performed for a period of time corresponding to the first frame to the last frame in an audio frame group, that is, performed on all the audio frames in the audio frame group. For example, when the time at which the first frame in the audio frame group is input is represented by 0 and the time at which the last frame in the audio frame group is input is represented by T, in the second embodiment, event detection is performed within a range from time 0 to time T. Here, the range from time 0 to time T is expressed as [0, T].

Event detection may also be performed within the time range [t1, t2] (0<t1<t2<T). In this case, the audio reference time TEin, which is an event occurrence time, may be determined by replacing the time range [t1, t2] with the time range [0, t2-t1], and the offset, t1, may be added to the audio reference time TEin. Then, the video correction time TEout may be determined using the resulting value (TEin+t1) (Formula 5).

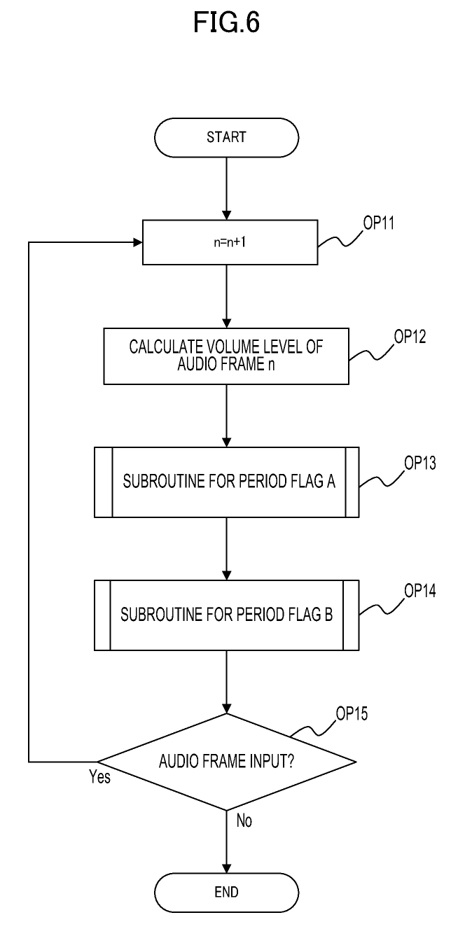

The time range for which event detection is to be performed may also be determined as follows. FIG. 6 is a diagram illustrating an example of a process flow for determining a time range for which event detection is to be performed.

The event detecting section 23 of the information processing apparatus 2 starts the process when an audio frame is input. The event detecting section 23 sets a variable n to value n+1 (OP11). The variable n is added to the audio frame input to the event detecting section 23 and serves as a value for identifying the audio frame. The variable n has an initial value of 0. In the following description, the term “audio frame n” refers to the audio frame that is input n-th.

The event detecting section 23 calculates the volume level of the audio frame n (OP12). The event detecting section 23 stores the volume level of the audio frame n in the main storage device 102. Then, the event detecting section 23 executes a subroutine A for a period flag A (OP13).

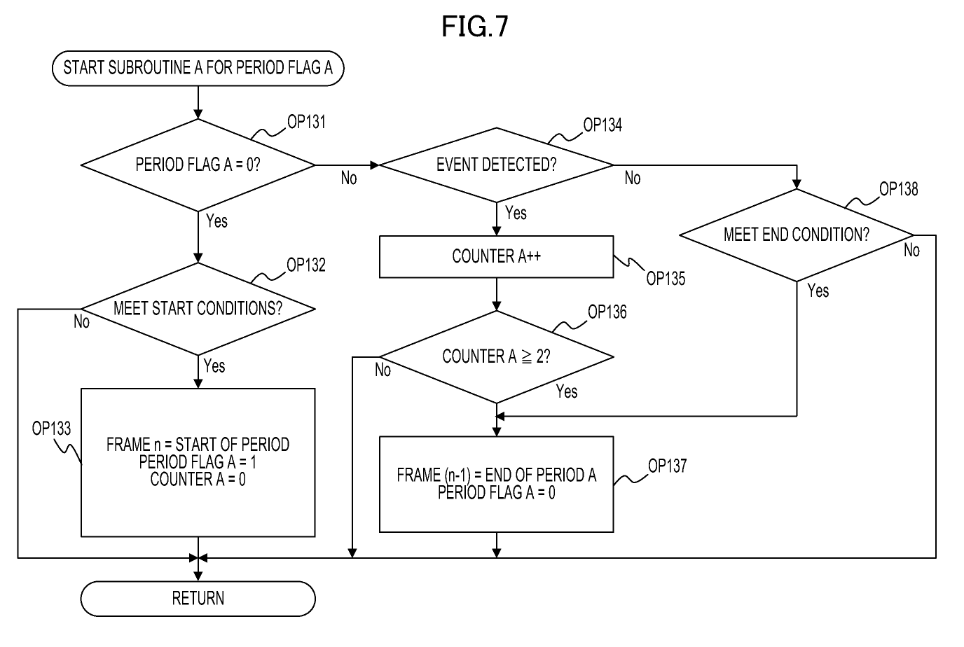

FIG. 7 is a flowchart illustrating an example of the subroutine A for the period flag A. The event detecting section 23 determines whether or not the period flag A is “0” (OP131). The term “period flag” means a flag indicating whether or not the audio frame n is included in the time range for which event detection is to be performed. A period flag of “0” indicates that the audio frame n is not included in the time range for which event detection is to be performed. A period flag of “1” indicates that the audio frame n is included in the time range for which event detection is to be performed. Note that the period flag A has an initial value of “1”. That is, the time range for which event detection is to be performed is started with the input of the first audio frame.

When the period flag A is “0” (OP131: Yes), the event detecting section 23 determines whether or not the volume level of the audio frame n and the volume level of the preceding audio frame n−1 meet the start conditions of the time range for which event detection is to be performed (hereinafter referred to as the “period”). For example, the start conditions of the period are:

### Period Start Conditions

ThAMax<Lv(n−1), and Lv(n)<ThAMin

where ThAMax denotes the maximum threshold volume level, ThAMin denotes the minimum threshold volume level value, and Lv(n) denotes the volume level of the audio frame n. In Example Modification 3, the point at which an event sound falls is set as the start of the period.

When the volume level of each of the audio frames n and n−1 meets the period start conditions (OP132: Yes), the event detecting section 23 determines that the audio frame n is the first frame of a period A. In this case, the event detecting section 23 updates the period flag A to “1”. The event detecting section 23 further sets a counter A to 0. The counter A counts the number of audio frames that can possibly have an event within one period (OP133).

When the volume level of at least one of the audio frames n and n−1 does not meet the period start conditions (OP132: No), the subroutine A for the period flag A ends, and then the processing of OP14 (FIG. 6) is executed.

When the period flag A is not “0”, that is, when the period flag A is “1” (OP131: No), the event detecting section 23 determines whether or not the audio frame n is an audio frame that can possibly have an event (OP134). The event detecting section 23 determines whether or not the audio frame n is an audio frame that can possibly have an event by using the following conditions:

### Determination Conditions for Event Detection Possibility

Lv(n−1)<ThAMin, and ThAMax<Lv(n)

The above determination conditions are used to determine whether or not the audio frame n corresponds to the point at which an event sound rises.

When it is determined that the audio frame n is an audio frame that can possibly have an event (OP134: Yes), the event detecting section 23 adds 1 to the value of the counter A (OP135), and determines whether or not the value of the counter A is greater than or equal to 2 (OP136).

When the value of the counter A is greater than or equal to 2 (OP136: Yes), since the period A includes two or more audio frames that can possibly have an event, the event detecting section 23 determines that the frame n−1 is the last frame of the period A. The event detecting section 23 further updates the period flag A to “0” (OP137). Counting the number of audio frames that can possibly have an event within a period using a counter allows detection of the presence of an audio frame that can possibly have one event within one period.

When the value of the counter A is not greater than or equal to 2 (OP136: No), the subroutine A for the period flag A ends. Then, the processing of OP14 (FIG. 6) is executed.

When it is determined that the audio frame n is not an audio frame that can possibly have an event (OP134: No), the event detecting section 23 determines whether or not the volume level of each of the audio frames n and n−1 meets the end conditions of the period (OP138). For example, the end conditions of the period are:

### Period End Conditions

Lv(n−1)<ThAMin, and ThAMin<Lv(n)<ThAMax

When the volume level of each of the audio frames n and n−1 meets the above period end conditions (OP138: Yes), the event detecting section 23 performs the processing of OP137. That is, the last frame of the period A is determined.

A subroutine B for a period flag B (OP14) may be performed by replacing the period flag A, the period A, and the counter A in the flowchart illustrated in FIG. 7 with a period flag B, a period B, and a counter B, respectively. Note that the period flag B has an initial value of “0” (while the period flag A has an initial value of “1”).

Referring back to FIG. 6, when an audio frame is input in OP15 (OP15: Yes), the processing of OP11 is executed again. For example, when no audio frames are input even after a certain period of time has elapsed, it is determined that no audio frames are input (OP15: No), and the process of extracting the time range for which event detection is to be performed ends.

The event detecting section 23 executes the flow processes illustrated in FIGS. 6 and 7, thereby specifying the first frame and the last frame of the time range for which event detection is to be performed. Thereafter, the event detecting section 23 executes an event detection process on an audio frame included between the specified first and last frames, and detects an audio frame having an event.

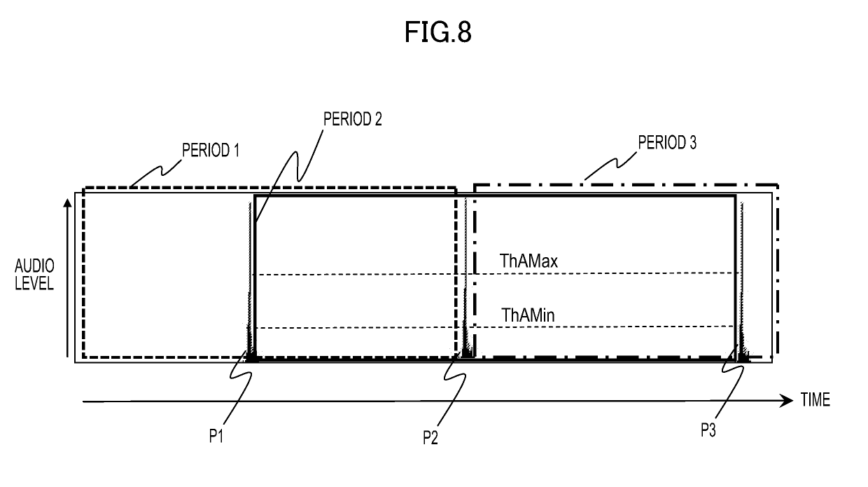

FIG. 8 is a diagram illustrating an example of a result obtained when the event detecting section 23 executes the process of extracting a time range for which event detection is to be performed. In the example illustrated in FIG. 8, a plurality of events P1, P2, and P3 are included in the frames between the first frame and the last frame in an audio frame group. The processes illustrated in FIGS. 6 and 7 can be performed to extract a time range from the point at which the volume level falls, which is caused by the event P1, to the point at which the volume level falls, which is caused by the event P3. In addition, the time range is also extracted so that the event P2 can be included around the middle of the time range. In the processes illustrated in FIGS. 6 and 7, furthermore, a plurality of period flags may be used and the initial values thereof may be set to be different from each other, thereby allowing extraction of overlapping periods, for example, period 1 including the event P1, period 2 including the event P2, and period 3 including the event 3. Therefore, even in a case where one audio frame group includes a plurality of events, a period including each of the events can be extracted, and the individual events can be detected.

Therefore, according to an aspect of the embodiments of the invention, any combinations of one or more of the described features, functions, operations, and/or benefits can be provided. A combination can be one or a plurality. The embodiments can be implemented as an apparatus (a machine) that includes computing hardware (i.e., a computing apparatus), such as (in a non-limiting example) any computer that can store, retrieve, process and/or output data and/or communicate (network) with other computers. According to an aspect of an embodiment, the described features, functions, operations, and/or benefits can be implemented by and/or use computing hardware and/or software. The information processing apparatus 1 may include a controller (CPU) (e.g., a hardware logic circuitry based computer processor that processes or executes instructions, namely software/program), computer readable recording media, transmission communication media interface (network interface), and/or a display device, all in communication through a data communication bus. In addition, an apparatus can include one or more apparatuses in computer network communication with each other or other apparatuses. In addition, a computer processor can include one or more computer processors in one or more apparatuses or any combinations of one or more computer processors and/or apparatuses. An aspect of an embodiment relates to causing one or more apparatuses and/or computer processors to execute the described operations. The results produced can be displayed on the display.

Program(s)/software implementing the embodiments may be recorded on non-transitory tangible computer-readable recording media. Examples of the computer-readable recording media include a magnetic recording apparatus, an optical disk, a magneto-optical disk, and/or volatile and/or non-volatile semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), DVD-ROM, DVD-RAM (DVD-Random Access Memory), BD (Blue-ray Disk), a CD-ROM (Compact Disc-Read Only Memory), a CD-R (Recordable) and a CD-RW.

The program/software implementing the embodiments may also be included/encoded as a data signal and transmitted over transmission communication media. A data signal moves on transmission communication media, such as wired network or wireless network, for example, by being incorporated in a carrier wave. The data signal may also be transferred by a so-called baseband signal. A carrier wave can be transmitted in an electrical, magnetic or electromagnetic form, or an optical, acoustic or any other physical form.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

The many features and advantages of the embodiments are apparent from the detailed specification and, thus, it is intended by the appended claims to cover all such features and advantages of the embodiments that fall within the true spirit and scope thereof. The claims may include the phrase “at least one of A, B and C” as an alternative expression that means one or more of A, B and C may be used, contrary to the holding in Superguide v. DIRECTV, 358 F3d 870, 69 USPQ2d 1865. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. An information processing apparatus, comprising:
a detecting section configured to detect an event sound from audio, the audio having been recorded when video was shot;
a calculating section configured to determine an event playback time at which an image associated with the event sound is played back in a video playback time sequence, the video playback time sequence corresponding to a playback speed lower than a shooting speed of the video; and
a determining section configured to determine an audio playback start time of the event sound during the video playback time sequence in accordance with the event playback time.

2. The information processing apparatus according to claim 1,
wherein the detecting section detects a first time at which an audio frame including the event sound is played back, the audio frame being included in an audio frame group of the audio and the first time being measured with respect to a recorded group start time corresponding to a position at which the audio frame group starts,
wherein the calculating section calculates a second time at which a video frame including an event corresponding to the event sound is played back in the video playback time sequence, the video frame being included in a video frame group of the video, and
wherein the determining section obtains the audio playback start time by subtracting the first time from the second time to determine when the audio frame group begins playback.

3. The information processing apparatus according to claim 2, further comprising:
a video time adding section configured to add a video playback time to each of video frames included in the video frame group, the video playback time corresponding to when one of the video frames is played back at the playback speed, and
an audio time adding section configured to add the second time to the audio frame including the event sound by adding audio playback times of the audio frame group to respective audio frames included in the audio frame group, the audio playback times being obtained using the audio playback start time of the audio frame group as an offset.

4. The information processing apparatus according to claim 2,
wherein the detecting section extracts a plurality of consecutive audio frames included in the audio frame group in accordance with a relationship between a signal characteristic of a current audio frame included in the audio frame group and a signal characteristic of a preceding audio frame preceding the current audio frame, and
wherein the detecting section detects the first time at which the audio frame is to be played back, when the plurality of consecutive audio frames include the audio frame including the event sound.

5. A tangible computer-readable recording medium having a program recorded thereon, the program causing, when executed by an information processing apparatus, the information processing apparatus to execute a method comprising:
inputting video captured at a predetermined shooting speed;
inputting audio recorded when the video was shot;
detecting an event sound from the audio;
calculating an event playback time at which an image associated with the event sound is played back in a video playback time sequence, the video playback time sequence corresponding to a playback speed lower than the predetermined shooting speed of the video;
determining an audio playback start time of the event sound during the video playback time sequence in accordance with the event playback time; and
outputting the audio playback start time of the event sound.

6. The tangible computer-readable recording medium according to claim 5,
wherein said detecting detects a first time at which an audio frame including the event sound is played back, the audio frame being included in an audio frame group of the audio and the first time being measured with respect to a position at which playback of the audio frame group starts,
wherein said calculating calculates a second time at which a video frame including an event corresponding to the event sound is played back in the video playback time sequence, the video frame being included in a video frame group of the video, and
wherein said determining obtains the audio playback start time by subtracting the first time from the second time to determine when the audio frame group begins playback.

7. The tangible computer-readable recording medium according to claim 6, wherein the method further comprises:
adding a video playback time to each of video frames included in the video frame group, the video playback time corresponding to when one of the video frames is played back at the playback speed, and
adding the second time to the audio frame including the event sound by adding audio playback times of the audio frame group to respective audio frames included in the audio frame group, the audio playback times being obtained using the audio playback start time of the audio frame group as an offset.

8. The tangible computer-readable recording medium according to claim 6,
wherein said detecting extracts a plurality of consecutive audio frames included in the audio frame group in accordance with a relationship between a signal characteristic of a current audio frame included in the audio frame group and a signal characteristic of a preceding audio frame preceding the current audio frame, and
wherein said detecting detects the first time at which the audio frame is to be played back, when the plurality of consecutive audio frames include the audio frame including the event sound.

9. An information generation method executed by an information processing apparatus, the method comprising:
inputting video captured at a predetermined shooting speed;
inputting audio recorded when the video was shot;
detecting an event sound from the audio;
calculating an event playback time at which an image associated with the event sound is played back in a video playback time sequence, the video playback time sequence corresponding to a playback speed lower than the predetermined shooting speed of the video;
determining an audio playback start time of the event sound during the video playback time sequence in accordance with the event playback time; and
outputting the audio playback start time of the event sound.

10. The information generation method according to claim 9,
wherein said detecting detects a first time at which an audio frame including the event sound is played back, the audio frame being included in an audio frame group of the audio and the first time being measured with respect to a position at which playback of the audio frame group starts,
wherein said calculating calculates a second time at which a video frame including an event corresponding to the event sound a video frame group of the video is played back in the video playback time sequence, the video frame being included in a video frame group of the video, and
wherein said determining obtains the audio playback start time by subtracting the first time from the second time to determine when the audio frame group begins playback.

11. The information generation method according to claim 10, further comprising:
adding a video playback time to each of video frames included in the video frame group, the video playback time corresponding to when one of the video frames is played back at the playback speed, and
adding the second time to the audio frame including the event sound by adding audio playback times of the audio frame group to respective audio frames included in the audio frame group, the audio playback times being obtained using the audio playback start time of the audio frame group as an offset.

12. The information generation method according to claim 10,
wherein said detecting extracts a plurality of consecutive audio frames included in the audio frame group in accordance with a relationship between a signal characteristic of a current audio frame included in the audio frame group and a signal characteristic of a preceding audio frame preceding the current audio frame, and
wherein when the plurality of consecutive audio frames include the audio frame including the event sound, said detecting detects the first time at which the audio frame is to be played back.

13. An information processing apparatus, comprising:
at least one storage device storing audio and video recorded together; and
a programmed processor, coupled to said at least one storage device, generating audio and video signals in a video playback time sequence corresponding to a playback speed slower than a shooting speed at which the video was recorded by detecting an event sound from the audio, determining an event playback time at which an image associated with the event sound is played back in the video playback time sequence, and determining an audio playback start time of the event sound during the video playback time sequence in accordance with the event playback time.

14. A playback device for reproducing audio and video in a video playback time sequence corresponding to a playback speed slower than a shooting speed at which the video was recorded, comprising:
at least one storage device storing audio and video recorded together;
a programmed processor, coupled to said at least one storage device, generating audio and video signals in a video playback time sequence corresponding to a playback speed slower than a shooting speed at which the video was recorded by detecting an event sound from the audio, determining an event playback time at which an image associated with the event sound is played back in the video playback time sequence, and determining an audio playback start time of the event sound during the video playback time sequence in accordance with the event playback time; and
a playback device, coupled to said programmed processor, reproducing the audio and the video in the video playback time sequence based on the audio and video signals.
